(19) United States
(12) Patent Application Publication
(10) Pub. No.: US 2006/0219700 A1
(43) Pub. Date: Oct. 5, 2006

(54) Pixel driving method, timing controller and liquid crystal display

(75) Inventors: Siow-Fang Chen, Dali City (TW); Kuei-Hsueh Chen, Mingjian Township (TW); Yao-Jen Hsieh, Baoshan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/235,798

(22) Filed: Sep. 27, 2005

(30) Foreign Application Priority Data
Mar. 31, 2005 (TW) 94110297

(51) Int. Cl. H05B 1/02

(52) U.S. Cl. 219/497

(57) ABSTRACT

A pixel driving method is used in a liquid crystal display. First, a temperature t of the liquid crystal display is detected. An initial level, and a target level are provided. A corresponding coefficient aₙ is looked up in a lookup table based on the initial level and the target level. An overdrive level OD is estimated by substituting the coefficient aₙ and a function of the temperature f(t) into the formula:

$$OD = {\sum }_{n = 0}^{N} {a}_{n} {f ( t )}^{n}$$

Thereafter, a pixel is driven by the overdrive level OD to reach the target level within a time frame. The lookup table comprises a plurality of columns and rows. The columns define the initial levels, and the rows define the target levels. Each of a plurality of coefficients aₙ corresponds to an intersection formed by one column and one row.

### BACKGROUND

The invention relates to a pixel driving method, and in particular, to a pixel driving method that compensates for temperature variation affecting a liquid crystal display.

Overdriving is a well known technique to enhance liquid crystal response time. FIG. 1 is a conventional overdrive signal timing chart. A pixel is driven with two stages in a time frame. The first stage is a writing stage, and the second stage is a sustaining stage. In this case, the pixel is destined to reach a target level L2 from an initial level L1. The initial level is associated with an initial voltage V1, and the target level L2 a target voltage V2. A voltage higher than V2 is applied in the writing stage to fasten the liquid crystal response, referred to as overdrive voltage V_{OD}. The level corresponding to the overdrive voltage V_{OD} is referred to as an overdrive level. The target voltage V2 is then applied in the sustaining stage to keep the level at the target level L2.

Liquid crystal response time is relative to environmental temperature. FIG. 2 shows various liquid crystal response curves by using the same overdriving level of 40° C. under different temperature, the horizontal-axis is frame time, and the vertical-axis is luminance. A curve T40 representing 40 centigrade, is taken as a basis for comparison. The initial level L1 and target level L2 generate a normal curve T40 by using the overdriving level at the 40° C. When the temperature is 60 centigrade, the initial level L1 and target level L2 generate an over-saturated curve T60 by using the overdriving level of 40° C., and image displayed may appear to be overly bright on the edge. Conversely, when the temperature is 20 centigrade, a curve T20 is generated, showing poor liquid crystal response that causes residual images when displayed.

FIG. 3a shows a conventional liquid crystal display comprising a plurality of LUTs 304. Each LUT 304 associates with a different temperature range. The temperature sensor 310 detects the temperature of the display panel 308, and reports to the multiplexer 306. The multiplexer 306 choose a corresponding LUT 304. By obtaining an initial level from a memory 302, and a target level from the timing controller, the multiplexer 306 estimates and outputs the overdrive level OD to the display panel 308. The target level is further stored in the memory 302, and then used as the next frame initial level in next frame time.

FIG. 3b shows a temperature table corresponding to the LUT 304. Capacity consumption of the memory 302 is proportional to the number of LUT 304, therefore the cost of temperature compensation is high.

### SUMMARY

An embodiment of the invention provides a pixel driving method for use in a liquid crystal display. First, a temperature t of the liquid crystal display is detected. An initial level, and a target level are provided. A corresponding coefficient aₙ is looked up in a lookup table based on the initial level and the target level. An overdrive level OD is estimated by substituting the coefficient aₙ and a function of the temperature f(t) into the formula:

$$OD = {\sum }_{n = 0}^{N} {a}_{n} {f ( t )}^{n}$$

Thereafter, a pixel is driven by the overdrive level OD to reach the target level within a frame time.

The lookup table comprises a plurality of columns and rows. The columns define initial levels, and the rows define target levels. Each of a plurality of coefficients aₙ corresponds to an intersection formed by one column and one row.

The initial level and the target level ranges are identical to the maximum display level of the liquid crystal display.

The columns define the initial levels having values divisible by a predetermined number, and the rows define the target levels having values divisible by the predetermined number.

When the initial level is not the predetermined number, the adjacent upper column and lower column are looked up to obtain a first initial level coefficient a_{n(i,j)} and a second initial level a_{n(i,j+1)}. When the target level is not the predetermined number, the adjacent upper row and lower row are looked up to obtain a first target level a_{n(p,q)} and a second target level a_{n(p,q+1)}; where i, j, p, q are the dummy indexs. The coefficients of first/second initial/target levels and the function of temperature f(t) are substituted into the formula

$$OD = {\sum }_{n = 0}^{N} {a}_{n} {f ( t )}^{n}$$

thereby four overdrive levels OD1, OD2, OD3 and OD4 are obtained respectively. Bi-linear interpolation is then performed by the four overdrive levels OD1, OD2, OD3 and OD4 to determine the overdrive level OD.

When determining the overdrive level OD, the overdrive level OD is truncated into integers. If the truncated overdrive level OD exceeds the maximum display level of the liquid crystal display, the overdrive level OD is limited to the maximum display level such as 255. If the truncated overdrive level OD is less than the minimum display level of the liquid crystal display, the overdrive level OD is limited to the minimum display level such as 0.

In a writing period, the pixel is driven by a voltage corresponding to the overdrive level OD. In a sustaining period, the voltage for the pixel is sustained at the corresponding target level.

For simplicity, N is set to 1, hence the formula is simplified to:

OD=a₁·f(t)+a₀, where a₁ denotes the slope and a₀ denotes the offset.

A corresponding slope a₁ and offset a₀ are looked up in the lookup table based on the initial level and the target level. The overdrive level OD is estimated by substituting the slope a₁, offset a₀ and the function of the temperature f(t) into the simplified formula.

When the initial level is not the predetermined number, the adjacent upper column and lower column are looked up to obtain the coefficients of a first initial level (a_{0(i,j)}, a_{1(i,j)}) and a second initial level (a_{0(i,j+1)}, a_{1(i,j+1)}). When the target level is not the predetermined number, the adjacent upper row and lower row are looked up to obtain the coefficients of a first target (a_{0(p,q)}, a_{1(p,q)}) and a second target (a_{0(p,q+1)}, a_{1(p,q+1)}). The first/second initial/target (a_{0(i,j)}, a_{1(i,j)}), (a_{0(i,j+1)}, a_{(i,j+1)}), (a_{0(p,q)}, a_{1(p,q)}), (a_{0(p,q+1)}, a_{1(p,q+1)}) and the function of temperature f(t) are substituted into the formula
OD=a1·f(t)+a₀

thereby four overdrive levels OD1, OD2, OD3 and OD4 are obtained respectively. Bi-linear interpolation is then performed by the four overdrive levels OD1, OD2, OD3 and OD4 to determine the overdrive level OD.

Some embodiments of the invention also provide a timing controller and a liquid crystal display performing the pixel driving method.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a conventional overdrive signal timing chart;

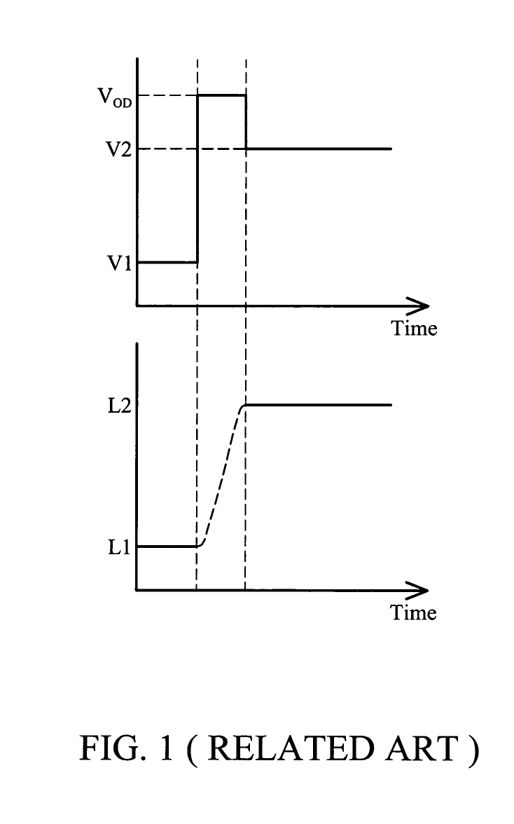

FIG. 2 shows various liquid crystal response curves under different temperature;

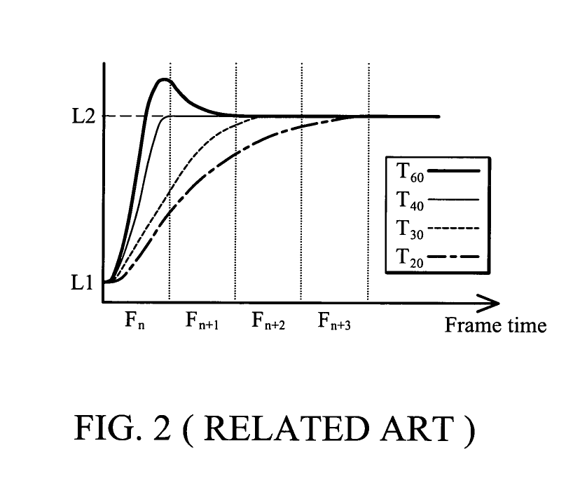

FIG. 3a shows a conventional liquid crystal display;

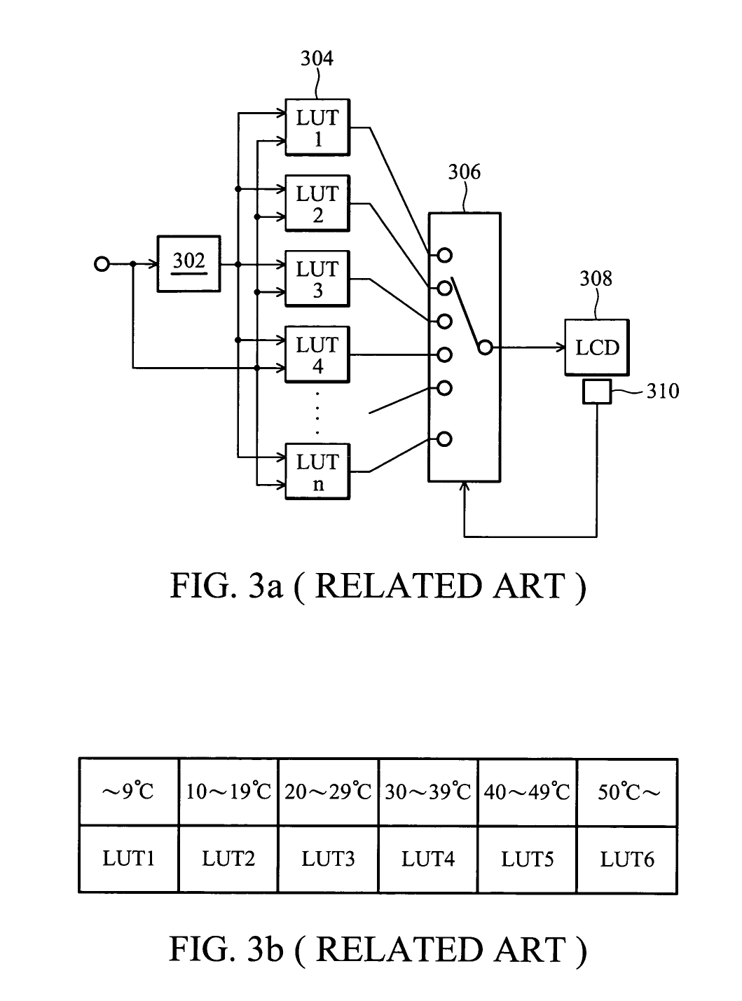

FIG. 3b shows a temperature table corresponding to the LUT 304;

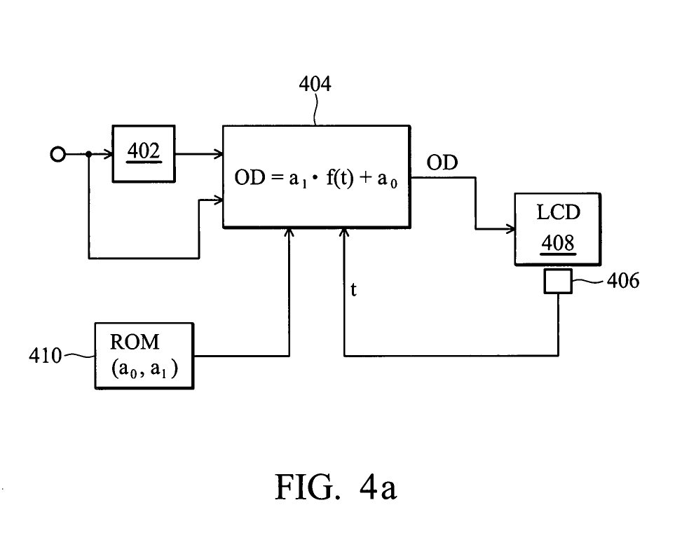

FIG. 4a shows an embodiment of the liquid crystal display according to the invention;

FIGS. 4b and 4c are embodiments of the lookup tables providing a₀ and a₁;

FIG. 5 shows an embodiment of the relationship between overdrive level OD and temperature; and

FIG. 6 is a flowchart according to an embodiment of the invention.

### DETAILED DESCRIPTION OF THE INVENTION

A detailed description of the invention is provided in the following.

An embodiment of the invention provides an approximation formula, such that the overdrive level OD can be estimated instead of looked up in the tables, thereby reducing the memory requirement of the lookup tables. The formula is:

$$OD = {\sum }_{n = 0}^{N} {a}_{n} {f ( t )}^{n} \qquad ( 1 )$$

The overdrive level OD, exceeding the target level, is then output to reduce the liquid crystal response time in the writing stage. In this case, N is set to 1, thus the equation (1) is simplified as:
OD=a₁·f(t)+a₀ (2)

Two tables are provided to define the values of the slope a₁ and the offset a₀, thereby the overdrive level OD can be calculated therein, and the requirement of memory capacity is reduced.

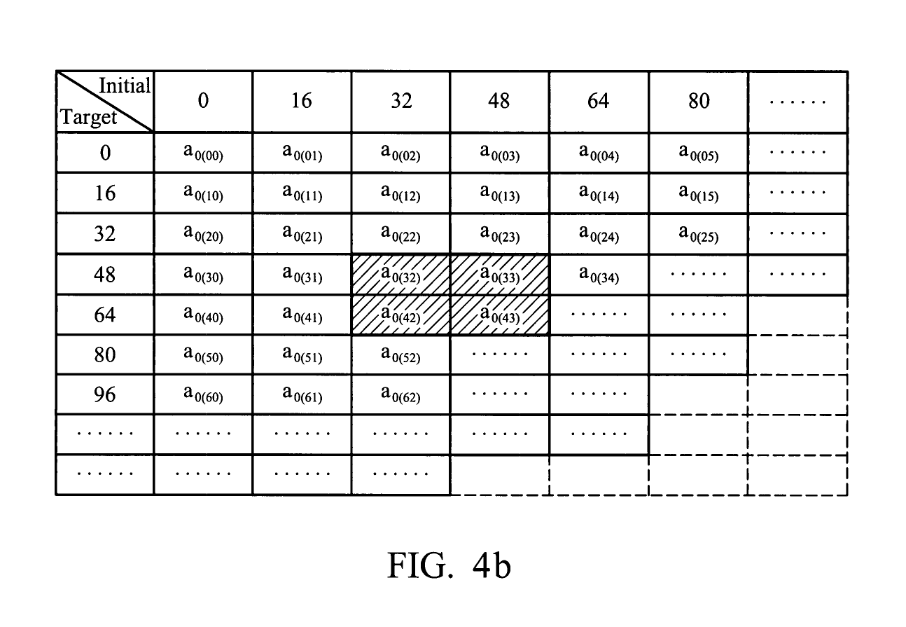

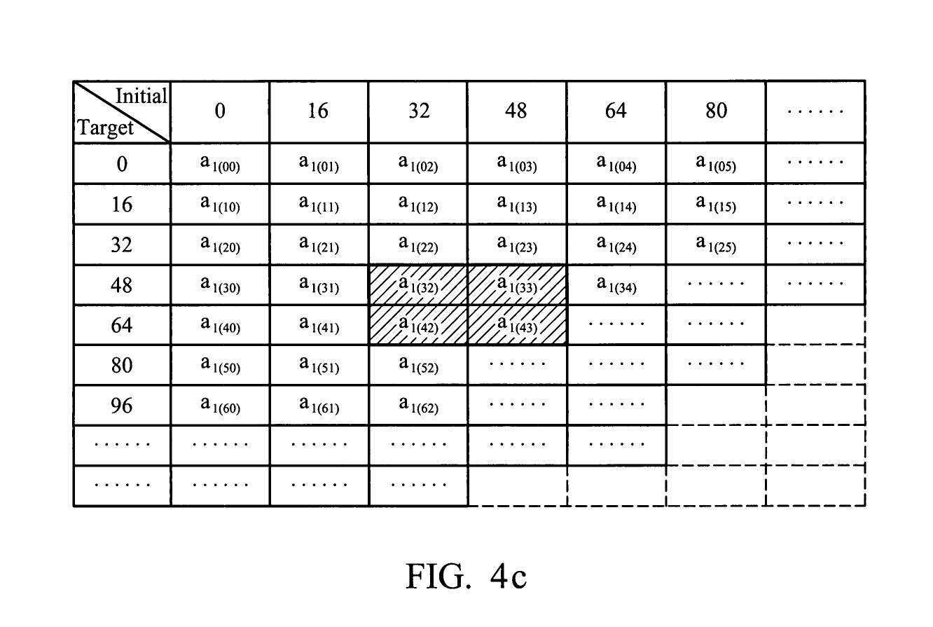

FIG. 4a shows an embodiment of the liquid crystal display according to the invention. The liquid crystal display comprises a timing controller 404, a temperature sensor 406, a display panel 408, a read only memory 410 and a memory 402. The temperature sensor 406 detects the temperature t of the display panel 408, and reports the detected result to the timing controller 404. The memory 402 stores an initial level corresponding to the current status of a pixel in the display panel 408. A target level is input to the timing controller 404, corresponding to a target status of the pixel. The timing controller 404 determines overdrive level OD by looking up the corresponding slope coefficient a₁ and offset coefficient a₀ in the read only memory 410 based on the initial level and the target level, and substituting the a₁, a₀, and the temperature t into the equation (2). The f(t) can be an approximation function that resembles liquid crystal physical behavior versus temperature variation. For example, f(t) can be any function of t, exp(t), ln(t), sin(t) or cos(t) and etc., or the combination thereof. The read only memory 410 can be EEPROM or FLASH ROM. The temperature sensor 406, alternatively, can be implemented within the display panel 408.

FIGS. 4b and 4c are embodiments of the coefficient lookup tables providing a₀ and a₁. Every level pair (initial level, target level) associates with one coefficient set (a₀, a₁). The coefficient sets are previously determined and configured at the manufacturing stage. A lookup table may provide all coefficient sets corresponding to all level pairs. For example, both the initial level and target level are 8 bits comprising 256 levels, thus 256×256 possible level pairs are available. Alternatively, a lookup table may be simplified to provide 16×16 coefficient sets associating to a portion of the possible level pairs. Specifically, the lookup table provides 16×16 coefficient sets associating with the initial level and target level being a multiple of 16. Moreover, coefficient sets associating to zero levels are included, therefore the lookup table comprises a total of 17×17 coefficient sets exactly. The corresponding coefficient sets of the initial levels and target levels not being a multiple of 16, can be calculated by a bi-interpolation method. As shown as the dark area in FIGS. 4b and 4c, when the initial level given is between 32 and 48, and the target level obtained is between 48 and 64, corresponding coefficients in the lookup tables form the sets (a₀₍₃₂₎, a₁₍₃₂₎), (a₀₍₃₃₎,a₁₍₃₃₎), (a₀₍₄₂₎,a₁₍₄₂₎), (a₀₍₄₃₎, a₁₍₄₃₎). The four sets are then substituted in the equation (2) to obtain four overdrive level OD, OD1, OD2, OD3 and OD4, and bi-interpolation is performed over the four ODs to obtain the expected OD. Considering circuit simplicity, linear interpolation can be used to substitute the bi-interpolation implementation.

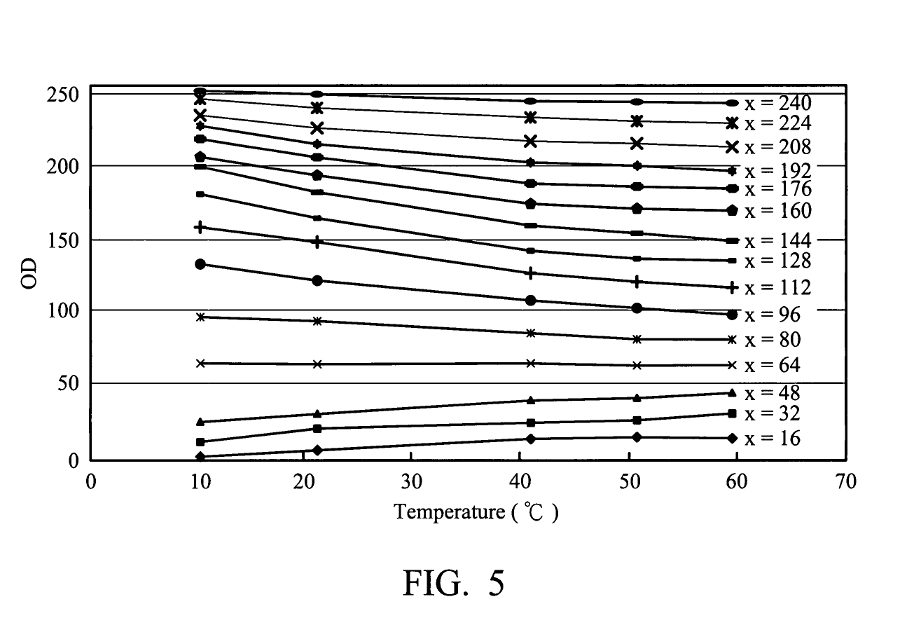

FIG. 5 shows an embodiment of the relationship between overdrive level OD and temperature. Consider a case where the initial level is 64, and target levels X are from 16 to 240. All of the curves, plotted according to laboratory experiments, are generalized to the equation OD=a₁·f(t)+a₀, where each curve associates to an individual set of (a₀, a₁). In this way, lookup table(s) providing the coefficient sets can be easily programmed and provided without significant memory consumption, for example, the coefficient sets (a₀, a₁) are previously defined at the manufacturing stage, or programmed through firmware update.

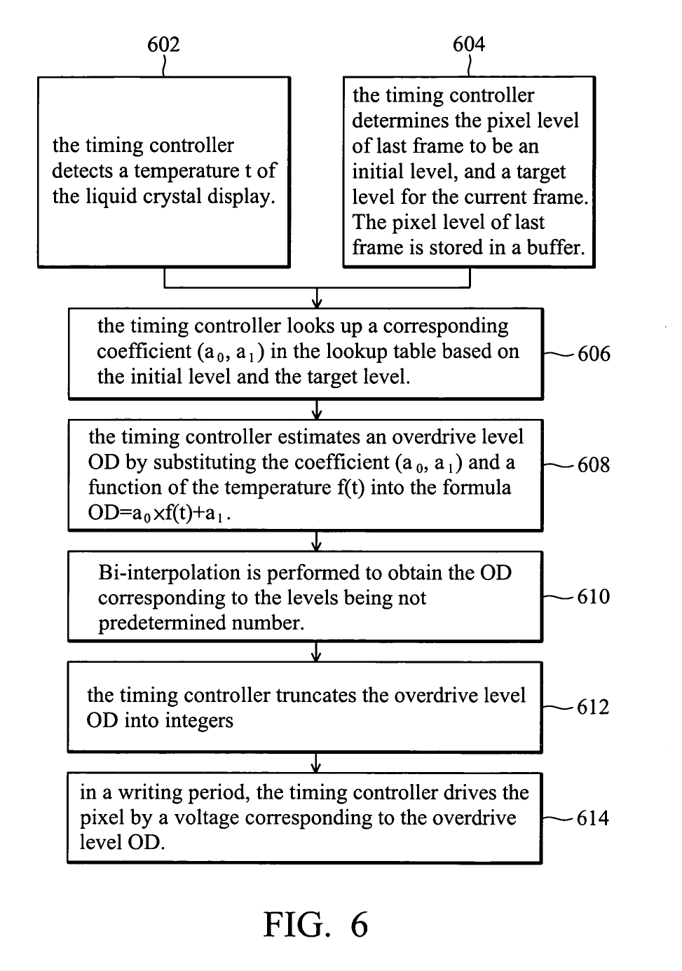

FIG. 6 is a flowchart according to an embodiment of the invention. In step 602, the timing controller detects a temperature t of the liquid crystal display. In step 604, the timing controller determines the pixel level of the last frame to be an initial level, and a target level for the current frame. The pixel level of last frame is stored in a buffer. In step 606, the timing controller looks up a corresponding coefficient (a₀, a₁) in the lookup table based on the initial level and the target level. In step 608, the timing controller estimates an overdrive level OD by substituting the coefficient (a₀, a₁) and a function of the temperature f(t) into the formula OD=a₁·f(t)+a₀. The LUT may only define the initial levels and target levels having values divisible by the predetermined number. For example, the defined levels are multiples of 16. In step 610, Bi-interpolation is performed to obtain the OD corresponding to levels not being multiples of 16. In step 612, the timing controller truncates the overdrive level OD into integers, if the truncated overdrive level OD exceeds the maximum display level of the liquid crystal display, the timing controller limits the overdrive level OD to the maximum display level, which is 255 in this case. Similarly, if the truncated overdrive level OD is less than the minimum display level of the liquid crystal display, timing controller limits the overdrive level OD to the minimum display level, which is 0 in this case. In step 614, in a writing period, the timing controller drives the pixel by a voltage corresponding to the overdrive level OD. In a sustain period, the timing controller sustains the voltage for the pixel at the corresponding target level. The corresponding scan line is activated during a write period, and disabled during the sustain period. For example, if a frame period is 16.6 ms, and the number of scan lines is 800, thus the writing period is 16.6 ms/800 lines, and the sustaining period is (16.6 ms−16.6 ms/800 lines).

While the invention has been described by way of example and in terms of the preferred embodiment, it is to be understood that the invention is not limited thereto. To the contrary, it is intended to cover various modifications and similar arrangements (as would be apparent to those skilled in the art) Therefore, the scope of the appended claims should be accorded the broadest interpretation so as to encompass all such modifications and similar arrangements.

What is claimed is:

1. A pixel driving method, for use in a liquid crystal display, comprising:
detecting a temperature t of the liquid crystal display;
providing an initial level, and a target level;
looking up a corresponding coefficient aₙ in a lookup table based on the initial level and the target level;
estimating an overdrive level OD by substituting the coefficient aₙ and a function of the temperature f(t) into a formula:
$$OD = {\sum }_{n = 0}^{N} {a}_{n} {f ( t )}^{n} ; and$$
driving a pixel at the overdrive level OD to reach the target level within a frame time.

2. The pixel driving method as claimed in claim 1, wherein the function of temperature f(t) approximates environmental temperature variations.

3. The pixel driving method as claimed in claim 1, wherein the lookup table comprises:
a plurality of columns, defining initial levels;
a plurality of rows, defining target levels; and
a plurality of coefficients aₙ, each corresponding to an intersection formed by one column and one row.

4. The pixel driving method as claimed in claim 3, wherein:
the initial level and the target level ranges identical to the maximum display level of the liquid crystal display;
the columns define the initial levels having values divisible by a predetermined number; and
the rows define the target levels having values divisible by the predetermined number.

5. The pixel driving method as claimed in claim 4, further comprising:
when the initial level is not the predetermined number, the adjacent upper column and lower column are looked up to obtain the coefficients of a first initial level a_{n(i,j)} and a second initial level a_{n(i,j+1)};
when the target level is not the predetermined number, the adjacent upper row and lower row are looked up to obtain the coefficients of a first target level a_{n(p,q)} and a second target level a_{n(p,q+1)};
substituting for the first/second initial/target levels and the function of temperature f(t) into the formula
$$OD = {\sum }_{n = 0}^{N} {a}_{n} {f ( t )}^{n}$$
thereby obtaining four overdrive levels OD1, OD2, OD3 and OD4 respectively; and
performing bi-linear interpolation by the four overdrive levels OD1, OD2, OD3 and OD4 to determine the overdrive level OD.

6. The pixel driving method as claimed in claim 1, wherein the step of determining the overdrive level OD comprises:
truncating the overdrive level OD into integers;
if the truncated overdrive level OD exceeds the maximum display level of the liquid crystal display, limiting the overdrive level OD to the maximum display level; and
if the truncated overdrive level OD is less than the minimum display level of the liquid crystal display, limiting the overdrive level OD to the minimum display level.

7. The pixel driving method as claimed in claim 1, further comprising:
in a writing period, driving the pixel by a voltage corresponding to the overdrive level OD; and
in a sustaining period, sustaining the voltage for the pixel at the corresponding target level.

8. The pixel driving method as claimed in claim 1, further comprising:
setting N=1, hence the formula is simplified - OD=a₁·f(t)+a₀, where a₁ denotes the slope and a₀ denotes the offset;
looking up a corresponding slope a₁ and offset a₀ in the lookup table based on the initial level and the target level; and
estimating the overdrive level OD by substituting the slope a₁, offset a₀ and the function of the temperature f(t) into the formula.

9. The pixel driving method as claimed in claim 8, further comprising:
when the initial level is not the predetermined number, the adjacent upper column and lower column are looked up to obtain the coefficients of a first initial (a_{0(i,j)}, a_{1(i j)}) and a second initial (a_{0(i,j+1)}, a_{1(i,j+1)});
when the target level is not the predetermined number, the adjacent upper row and lower row are looked up to obtain a first target (a_{0(p,q)}, a_{1(p,q)}) and a second target (a_{0(p,q+1)}, a_{1(p,q+1)});
substituting for the first/second initial/target (a_{0(i,j)}, a_{1(i,j)}), (a_{0(i,j+1)}, a_{1(i,j+1)}), (a_{0(p,q)}, a_{1(p,q)}), (a_{0(p,q+1)}, a_{1(p,q+1)}) and the function of temperature f(t) into the formula
OD=a1·f(t)+a₀
thereby obtaining four overdrive levels OD1, OD2, OD3 and OD4 respectively; and
performing bi-linear interpolation by the four overdrive levels OD1, OD2, OD3 and OD4 to determine the overdrive level OD.

10. A timing controller, driving at least one pixel in a liquid crystal display, comprising at least one lookup table, wherein:
the timing controller detects a temperature t of the liquid crystal display;
the timing controller determines an initial level, and a target level;
the timing controller looks up a corresponding coefficient aₙ in the lookup table based on the initial level and the target level;
the timing controller estimates an overdrive level OD by substituting the coefficient aₙ and a function of the temperature f(t) into the formula:
$$OD = {\sum }_{n = 0}^{N} {a}_{n} {f ( t )}^{n} ; and$$
the timing controller drives a pixel by the overdrive level OD to reach the target level within a frame time.

11. The timing controller as claimed in claim 10, wherein the function of temperature f(t) approximates environmental temperature variations.

12. The timing controller as claimed in claim 10, wherein the lookup table comprises:
a plurality of columns and rows, defining initial levels and target levels; and
a plurality of coefficients aₙ, each corresponding to an intersection formed by one column and one row.

13. The timing controller as claimed in claim 12, wherein:
the initial level and the target level ranges are identical to the maximum display level of the liquid crystal display;
the columns define the initial levels having values divisible by a predetermined number; and
the rows define the target levels having values divisible by the predetermined number.

14. The timing controller as claimed in claim 13, further performing the following operations:
when the initial level is not the predetermined number, the adjacent upper column and lower column are looked up to obtain a first initial level a_{n(i,j)} and a second initial level a_{n(i,j+1)};
when the target level is not the predetermined number, the adjacent upper row and lower row are looked up to obtain a first target level a_{n(p,q)} and a second target level a_{n(p,q+1)};
substituting for the first/second initial/target levels and the function of temperature f(t) into the formula
$$OD = {\sum }_{n = 0}^{N} {a}_{n} {f ( t )}^{n}$$
thereby obtaining four overdrive levels OD1, OD2, OD3 and OD4 respectively; and
performing bi-linear interpolation by the four overdrive levels OD1, OD2, OD3 and OD4 to determine the overdrive level OD.

15. The timing controller as claimed in claim 10, further truncates the overdrive level OD into integers, wherein:
if the truncated overdrive level OD exceeds the maximum display level of the liquid crystal display, limiting the overdrive level OD to the maximum display level;
and if the truncated overdrive level OD is less than the minimum display level of the liquid crystal display, limiting the overdrive level OD to the minimum display level.

16. The timing controller as claimed in claim 10, the timing controller further sets N=1, hence the formula is simplified to:
OD=a₁·f(t)+a₀, where a₁ denotes the slope and a₀ denotes the offset;
the timing controller looks up a corresponding slope a₁ and offset a₀ in the lookup table based on the initial level and the target level; and
the timing controller estimates the overdrive level OD by substituting the slope a₁, offset a₀ and the function of the temperature f(t) into the formula.

17. The timing controller as claimed in claim 16, further performs the following steps:
when the initial level is not the predetermined number, the adjacent upper column and lower column are looked up to obtain a first initial (a_{0(i,j)}, a_{1(i,j)}) and a second initial (a_{0(i,j+1)}, a_{1(i,j+1)});
when the target level is not the predetermined number, the adjacent upper row and lower row are looked up to obtain a first target (a_{0(p,q)}, a_{1(p,q)}) and a second target (a_{0(p,q+1)}, a_{1(p,q+1)});
substituting the first/second initial/target (a_{0(i,j)}, a_{1(i,j)}), (a_{0(i,j+1)}, a_{1(i,j+1)}), (a_{0(p,q)}, a_{1(p,q)}), (a_{0(p,q+1)}, a_{1(p,q+1)}) and the function of temperature f(t) into the formula
OD=a1·f(t)+a₀
thereby obtaining four overdrive levels OD1, OD2, OD3 and OD4 respectively; and
performing bi-linear interpolation by the four overdrive levels OD1, OD2, OD3 and OD4 to determine the overdrive level OD.

18. A liquid crystal display, comprising:
a panel module, comprising at least one pixel;
a timing controller, driving the pixel;
a temperature sensor, coupled to the timing controller, sensing a temperature t of the panel module;
a memory device, coupled to the timing controller, storing an initial level;
a lookup table comprising:
a plurality of columns and rows, defining initial levels and target levels; and
a plurality of coefficients aₙ, each corresponding to an intersection formed by one column and one row;
wherein:
the timing controller receives a target level;
the timing controller looks up a corresponding coefficient aₙ in the lookup table based on the initial level and the target level;
the timing controller estimates an overdrive level OD by substituting the coefficient aₙ and a function of the temperature f(t) into the formula:
$$OD = {\sum }_{n = 0}^{N} {a}_{n} {f ( t )}^{n} ; and$$
the timing controller drives the pixel by the overdrive level OD to reach the target level within a frame time.

19. The liquid crystal display as claimed in claim 18, wherein the function of temperature f(t) approximates environmental temperature variations.

20. The liquid crystal display as claimed in claim 18, further comprising a read only memory coupled to the timing controller for storing the lookup table.

21. The liquid crystal display as claimed in claim 20, wherein:
the initial level and the target level ranges identical to the maximum display level of the liquid crystal display;
the columns define the initial levels having values divisible by a predetermined number; and
the rows define the target levels having values divisible by the predetermined number.

22. The liquid crystal display as claimed in claim 21, wherein the timing controller performs the following operations:
when the initial level is not the predetermined number, the adjacent upper column and lower column are looked up to obtain a first initial level a_{n(i,j)} and a second initial level a_{n(i,j+1)};
when the target level is not the predetermined number, the adjacent upper row and lower row are looked up to obtain a first target level a_{n(p,q)} and a second target level a_{n(p,q+1)};
substituting the first/second initial/target levels and the function of temperature f(t) into the formula
$$OD = {\sum }_{n = 0}^{N} {a}_{n} {f ( t )}^{n}$$
thereby obtaining four overdrive levels OD1, OD2, OD3 and OD4 respectively; and
performing bi-linear interpolation by the four overdrive levels OD1, OD2, OD3 and OD4 to determine the overdrive level OD.

23. The liquid crystal display as claimed in claim 18, wherein:
the timing controller truncates the overdrive level OD into integers;
if the truncated overdrive level OD exceeds the maximum display level of the liquid crystal display, the timing controller limits the overdrive level OD to the maximum display level; and
if the truncated overdrive level OD is less than the minimum display level of the liquid crystal display, the timing controller limits the overdrive level OD to the minimum display level.

24. The liquid crystal display as claimed in claim 18, wherein the memory device stores the target level for use as the next frame initial level.

25. The liquid crystal display as claimed in claim 18, wherein the timing controller further sets N=1, hence the formula is simplified to:
OD=a₁·f(t)+a₀, where a₁ denotes the slope and a₀ denotes the offset;
the timing controller looks up a corresponding slope a₁ and offset a₀ in the lookup table based on the initial level and the target level; and
the timing controller estimates the overdrive level OD by substituting the slope a₁, offset a₀ and the function of the temperature f(t) into the formula.

26. The liquid crystal display as claimed in claim 25, wherein:
when the initial level is not the predetermined number, the adjacent upper column and lower column are looked up to obtain a first initial (a_{0(i,j)}, a_{1(i,j)}) and a second initial (a_{0(i,j+1)}, a_{1(i,j+1)});
when the target level is not the predetermined number, the adjacent upper row and lower row are looked up to obtain a first target (a_{0(p,q)}, a_{1(p,q)}) and a second target (a_{0(p,q+1)}, a_{1(p,q+1)});
substituting the first/second initial/target (a_{0(i,j)}, a_{1(i,j)}), (a_{0(i,j+1)}, a_{1(i,j+1)}), (a_{0(p,q)}, a_{1(p,q)}), (a_{0(p,q+1)}, a_{1(p,q+1)}) and the function of temperature f(t) into the formula
OD=a₁·f(t)+a₀
thereby obtaining four overdrive levels OD1, OD2, OD3 and OD4 respectively; and
performing bi-linear interpolation by the four overdrive levels OD1, OD2, OD3 and OD4 to determine the overdrive level OD.
